(19) United States
(12) Patent Application Publication
(10) Pub. No.: US 2022/0350206 A1
(43) Pub. Date: Nov. 3, 2022

(54) LIQUID CRYSTAL DISPLAY, LIQUID CRYSTAL DISPLAY DEVICE

(71) Applicant: SHENZHEN CHINA STAR OPTOELECTRONICS SEMICONDUCTOR DISPLAY TECHNOLOGY CO., LTD., Shenzhen (CN)

(72) Inventor: Bo Hai, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 17/254,147

(22) PCT Filed: Nov. 17, 2020
(86) PCT No.: PCT/CN2020/129371

§ 371 Date: Dec. 18, 2020

(30) Foreign Application Priority Data
Oct. 9, 2020 (CN) 202011071385.2

(51) Int. Cl. G02F 1/1343; G02F 1/1335

(52) U.S. Cl. CPC G02F 1/134309; G02F 1/133531; G02F 1/13439; G02F 2201/123

(57) ABSTRACT

The present application provides a liquid crystal display screen and a liquid crystal display device. The liquid crystal display includes a first substrate and a second substrate that are arranged oppositely. The slit angles of the slits of at least part of the pixel electrodes on the first substrate are set not equal to 45 degrees. The slit angles ranging from 0 degrees to 39.99 degrees can alleviate light leakage of the liquid crystal display in the dark state at a horizontal viewing angle. The slit angles ranging from 50.01 degrees to 90 degrees can alleviate light leakage of the liquid crystal display in the dark state at the vertical viewing angle.

### BACKGROUND OF INVENTION

### Field of Invention

The present application relates to the field of display technology, in particular to a liquid crystal display and a liquid crystal display device.

### Description of Prior Art

With increase of the viewing angle of the thin-film transistor LCD (TFT-LCD), contrast of an image continues to decrease, and definition of the image gradually decreases, due to the fact that the birefringence of the liquid crystal molecules in the liquid crystal layer changes with the observation angle. The wide viewing angle compensation film can be used to compensate, which can effectively reduce light leakage of the image in a dark state, and can greatly increase within a certain viewing angle. The contrast of the image. The compensation principle of the wide viewing angle compensation film is generally to correct the phase difference generated by the liquid crystal at different viewing angles, so that the birefringence properties of the liquid crystal molecules are compensated symmetrically. However, the wide viewing angle compensation film cannot compensate the light leakage in the dark state at a horizontal viewing angle and the light leakage in the dark state at a vertical viewing angle. Since the light leakage in the dark state at the horizontal viewing angle cannot be compensated, quality of the image in the dark state at the horizontal viewing angle is impacted, and a relative position of a viewer and the LCD screen determines whether or not the horizontal viewing angle will be easier to be seen by the viewer, so the contrast and clarity of the horizontal viewing angle have the greatest affect on the viewing effect.

Therefore, the problems of light leakage in the dark state at a horizontal viewing angle and light leakage in the dark state at a vertical viewing angle of the existing liquid crystal display needs to be solved.

### SUMMARY OF INVENTION

The present application provides a liquid crystal display screen and a liquid crystal display device to alleviate the technical problems of light leakage in the dark state at a horizontal viewing angle and light leakage in the dark state at a vertical viewing angle of the existing liquid crystal display screen.

In order to solve the above problems, the technical solutions provided by the present application are as follows:

An embodiment of the present application provides a liquid crystal display screen, which includes a first substrate; a second substrate disposed opposite to the first substrate; a liquid crystal layer disposed between the first substrate and the second substrate; and a plurality of pixel electrodes arranged on a surface of the first substrate facing the liquid crystal layer, wherein each of the pixel electrodes has a plurality of slits, and slit angles of the slits of at least part of the pixel electrodes are not equal to 45 degrees.

In the liquid crystal display screen provided by an embodiment of the present application, the slit angles range from 0 degrees to 39.99 degrees, and are configured to alleviate light leakage at a horizontal viewing angle of the liquid crystal display in a dark state.

In the liquid crystal display screen provided by an embodiment of the present application, the slit angles range from 34.99 degrees to 39.99 degrees.

In the liquid crystal display screen provided by an embodiment of the present application, the slit angles range from 50.01 degrees to 90 degrees, and are configured to alleviate light leakage at a vertical viewing angle of the liquid crystal display in a dark state.

In the liquid crystal display screen provided by an embodiment of the present application, the slit angle ranges from 50.01 degrees to 55.01 degrees.

In the liquid crystal display screen provided by an embodiment of the present application, the liquid crystal display further includes a lower polarizer and an upper polarizer, the lower polarizer is attached to a surface of the first substrate away from the liquid crystal layer, and the upper polarizer is attached to a surface of the second substrate away from the liquid crystal layer.

In the liquid crystal display screen provided by an embodiment of the present application, a transmission axis of the lower polarizer is 0 degrees.

In the liquid crystal display screen provided by an embodiment of the present application, a transmission axis of the upper polarizer is 90 degrees.

In the liquid crystal display screen provided by an embodiment of the present application, the at least part of the pixel electrodes are pixel electrodes of green sub-pixels.

In the liquid crystal display screen provided by an embodiment of the present application, a material of the pixel electrode includes indium tin oxide.

An embodiment of the present application further provides a liquid crystal display device, which includes a liquid crystal display screen, and the liquid crystal display screen includes a first substrate; a second substrate disposed opposite to the first substrate; a liquid crystal layer disposed between the first substrate and the second substrate; and a plurality of pixel electrodes arranged on a surface of the first substrate facing the liquid crystal layer, wherein each of the pixel electrodes has a plurality of slits, and slit angles of the slits of at least part of the pixel electrodes are not equal to 45 degrees.

In the liquid crystal display device provided by an embodiment of the present application, the slit angles range from 0 degrees to 39.99 degrees, and are configured to alleviate light leakage at a horizontal viewing angle of the liquid crystal display in a dark state.

In the liquid crystal display device provided by an embodiment of the present application, the slit angles range from 34.99 degrees to 39.99 degrees.

In the liquid crystal display device provided by an embodiment of the present application, the slit angles range from 50.01 degrees to 90 degrees, and are configured to alleviate light leakage at a vertical viewing angle of the liquid crystal display in a dark state.

In the liquid crystal display device provided by an embodiment of the present application, the slit angles range from 50.01 degrees to 55.01 degrees.

In the liquid crystal display device provided by an embodiment of the present application, the liquid crystal display further includes a lower polarizer and an upper polarizer, the lower polarizer is attached to a surface of the first substrate away from the liquid crystal layer, and the upper polarizer is attached to a surface of the second substrate away from the liquid crystal layer.

In the liquid crystal display device provided by an embodiment of the present application, a transmission axis of the lower polarizer is 0 degrees.

In the liquid crystal display device provided by an embodiment of the present application, a transmission axis of the upper polarizer is 90 degrees.

In the liquid crystal display device provided by an embodiment of the present application, the at least part of the pixel electrodes are pixel electrodes of green sub-pixels.

In the liquid crystal display device provided by an embodiment of the present application, a material of the pixel electrode includes indium tin oxide.

The beneficial effects of the present application are that: in the liquid crystal display and the liquid crystal display device provided by the present application, by setting the slit angles of the plurality of slits of at least part of the pixel electrodes to a specific angle not equal to 45 degrees, light leakage in a dark state at a horizontal viewing angle or light leakage in a dark state at a vertical viewing angle is improved, which further improves the contrast of the display screen.

### BRIEF DESCRIPTION OF DRAWINGS

In order to more clearly illustrate the embodiments or the technical solutions of the existing art, the drawings illustrating the embodiments or the existing art will be briefly described below. Obviously, the drawings in the following description merely illustrate some embodiments of the present invention. Other drawings may also be obtained by those skilled in the art according to these figures without paying creative work.

FIG. 1 is a schematic side view of a structure of a liquid crystal display screen provided by an embodiment of the present application.

FIG. 2 is a schematic side view of a structure of the upper polarizer provided by an embodiment of the present application.

FIG. 3 is a schematic side view of a structure of a lower polarizer provided by an embodiment of the present application.

FIG. 4 is a schematic top view of the structure of a pixel electrode provided by an embodiment of the present application.

FIG. 5 is a schematic diagram of the light leakage distribution in the dark state when a slit angle of slits of the pixel electrode is 45 degrees according to an embodiment of the present application.

FIG. 6 is a schematic distribution diagram of light leakage in a dark state when a slit angle of a pixel electrode is 35 degrees according to an embodiment of the present application.

FIG. 7 is a schematic distribution diagram of light leakage in a dark state when a slit angle of a pixel electrode is 55 degrees according to an embodiment of the present application.

FIG. 8 is a schematic distribution diagram of brightness corresponding to different slit angles of pixel electrodes in a dark state at different viewing angles provided by an embodiment of the present application.

FIG. 9 is a schematic distribution diagram of light leakage values in a dark state at a horizontal viewing angle corresponding to different slit angles of pixel electrodes at different viewing angles according to an embodiment of the present application.

FIG. 10 is a schematic diagram of spatial distribution of each viewing angle provided by an embodiment of the present application.

FIG. 11 is a schematic distribution diagram of the transmittance corresponding to different slit angles of pixel electrodes provided by an embodiment of the present application.

### DETAILED DESCRIPTION OF PREFERRED EMBODIMENTS

The following description of the various embodiments is provided to illustrate the specific embodiments of the invention. Directional terms mentioned in the present invention, such as “vertical”, “horizontal”, “upper”, “bottom”, “pre”, “post”, “left”, “right”, “inside”, “outside”, “side”, etc., only refer to the direction of the additional drawing. Therefore, the directional terminology used is for the purpose of illustration and understanding of the invention. In the drawings, structurally similar elements are denoted by the same reference numerals. In the drawings, the thickness of some layers and regions is exaggerated for clear understanding and ease of description. That is, the size and thickness of each component shown in the drawings are arbitrarily shown, but the present application is not particularly limited thereto.

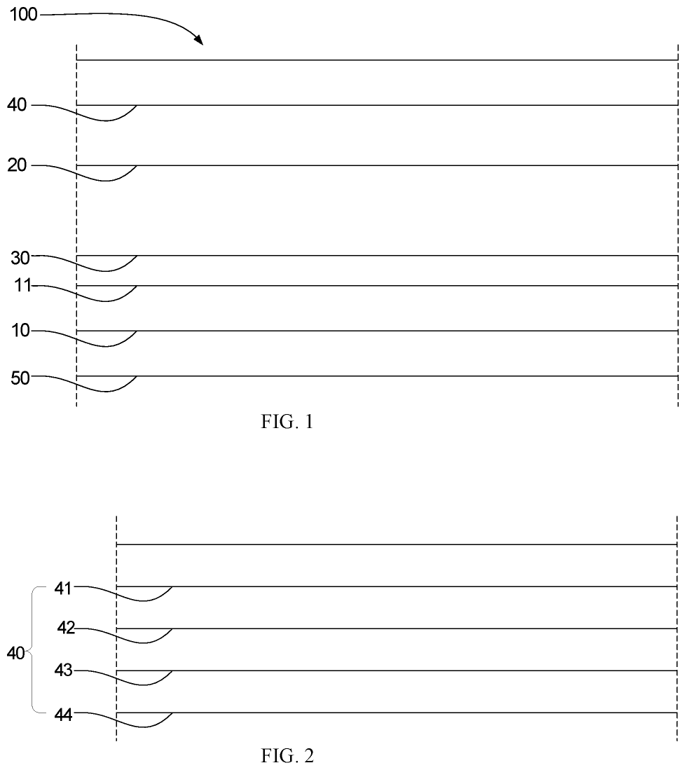

In an embodiment, a liquid crystal display is provided, and a display mode of the liquid crystal display is a vertical alignment (VA) display mode. Of course, the present application is not particularly limited thereto, and the present application only takes the liquid crystal display screen in vertical alignment display mode as an example. As shown in FIG. 1, the liquid crystal display screen 100 includes a first substrate 10 and a second substrate 20 disposed oppositely, a liquid crystal layer 30 disposed between the first substrate 10 and the second substrate 20, an upper polarizer 40, and a lower polarizer 50. The lower polarizer 50 is attached to a surface of the first substrate 10 away from the liquid crystal layer 30, and the upper polarizer 40 is attached to a surface of the second substrate 20 away from the liquid crystal layer 30, wherein a plurality of pixel electrodes 11 are provided on a surface of the first substrate 10 facing the liquid crystal layer 30, each of the pixel electrodes has a plurality of slits, and slit angles of the slits of at least part of the pixel electrodes are not equal to 45 degrees.

It should be noted that the slit angle in the present application refers to an angle between a slit of the pixel electrode and a transmission axis of the lower polarizer. The transmission axis of the lower polarizer refers to an axis of the lower polarizer that allows light to pass through, light parallel to the axis can pass through, and light perpendicular to the axis is absorbed, and the present application defines an angle of the transmission axis parallel to a horizontal direction of the liquid crystal display as 0 degrees.

Specifically, the first substrate 10 is an array substrate, and the second substrate 20 is a color filter substrate. The array substrate can be a gate driver on array (GOA) substrate or one of other conventional array substrates. The array substrate includes a thin-film transistor and the like, and the pixel electrode is connected to the thin-film transistor. It can be understood that the array substrate further includes a plurality of other layers, and the liquid crystal display also includes an alignment layer, etc., which will not be described in detail herein.

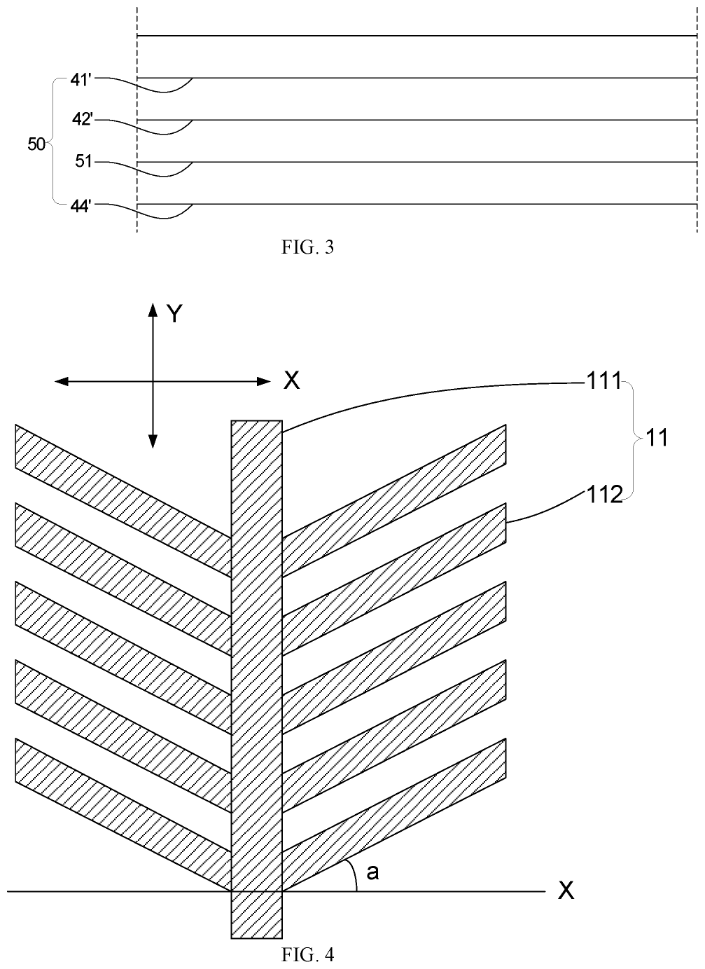

Specifically, a structure of the upper polarizer 40 is shown in FIG. 2. The upper polarizer 40 includes a first triacetyl cellulose (TAC) layer 41, a polarizing layer 42, a second triacetyl cellulose layer. 43, and a pressure-sensitive adhesive (PSA) layer 44, wherein when the upper polarizer 40 is disposed in the liquid crystal display 100, the pressure-sensitive adhesive layer 44 is close to the second substrate 20. A structure of the lower polarizer 50 is shown in FIG. 3, the lower polarizer 50 includes a first triacetyl cellulose layer 41′, a polarizing layer 42′, a biaxial compensation film 51, and a pressure-sensitive adhesive layer 44′, wherein when the lower polarizer 50 is disposed in the liquid crystal display 100, the pressure-sensitive adhesive layer 44′ is close to the first substrate 10. The pressure-sensitive adhesive layer mainly plays a role of adhesive connection. The polarizing layer, that is, a PVA layer, is made of polyvinyl alcohol, and its specific configuration can be determined by its transmission axis angle. The first triacetyl cellulose layer and the second triacetyl cellulose layer are mainly configured to protect the PVA layer, improve the mechanical properties of the PVA layer, and prevent the PVA layer from shrinking.

Further, the transmission axis of the lower polarizer 50 is 0 degrees, and the transmission axis of the upper polarizer 40 is 90 degrees, that is, the transmission axis of the lower polarizer 50 and the transmission axis of the upper polarizer 40 are perpendicular to each other. As shown in FIG. 4, the transmission axis X of the lower polarizer 50 is horizontal, and the transmission axis Y of the upper polarizer 40 is vertical. Of course, the transmission axis of the lower polarizer is 0 degrees, and the transmission axis of the upper polarizer is 90 degrees, which are only parameters set for the conventional liquid crystal display in the VA display mode. For an unconventional liquid crystal display in the VA display mode, the angle of the transmission axis X of the lower polarizer can be M degrees (M is not equal to 0), while the angle of the transmission axis Y of the upper polarizer is (M+90) degrees, and the transmission axis of the lower polarizer and the transmission axis of the upper polarizer are still perpendicular to each other. The slit angle of the slit of the pixel electrode is an included angle of the slit with respect to the transmission axis X of the lower polarizer.

It should be noted that the liquid crystal display screen of this embodiment is described only by taking a compensation structure of a single-layered biaxial compensation film where a biaxial compensation film is provided in a lower polarizer as an example, but the present application is not particularly limited thereto. The upper polarizer and the lower polarizer of the liquid crystal display of the present application may not be provided with biaxial compensation films therein, or in order to better reduce light leakage of an image in the dark state and improve contrast at a large viewing angle, the liquid crystal display of the present application may also adopt a double-layered biaxial compensation film, that is, a biaxial compensation film is also provided in the upper polarizer. Specifically, a biaxial compensation film is used to replace the second triacetyl cellulose layer between the pressure-sensitive adhesive layer and the polarizing layer in the upper polarizer to form the same structure as the lower polarizer.

Specifically, as shown in the pixel electrode 11 in FIG. 4, the pixel electrode 11 includes a main electrode 111 and branch electrodes 112, and the branch electrodes 112 extend in different directions along the main electrode 111. The main electrode 111 divides the pixel electrode 11 into two domains, and the branch electrodes 112 in the two domains may be symmetrically distributed with respect to the main electrode 111.

Specifically, the material of the pixel electrode includes transparent electrode materials such as indium tin oxide (ITO).

Further, still referring to FIG. 4, the slit angles a of the plurality of slits of the pixel electrode 11 are not equal to 45 degrees. The slit angles a of the plurality of slits of the pixel electrode 11 are the angles between the branch electrodes 112 and the transmission axis X of the lower polarizer. That is, the branch electrodes 112 are arranged at a certain slit angle a with respect to the transmission axis X of the lower polarizer.

Further, the slit angle a is set to a range from 0 degrees to 39.99 degrees to alleviate the light leakage of the liquid crystal display in the dark state at a horizontal viewing angle.

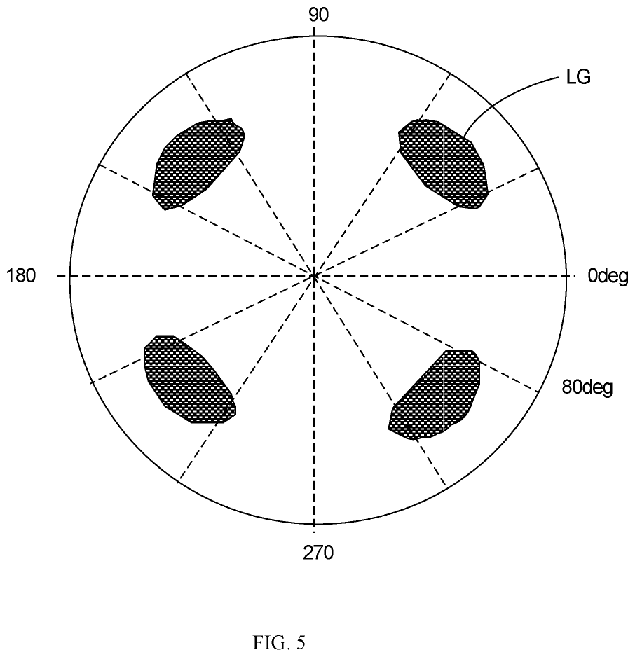

Specifically, the influence of different slit angles a of slits of a pixel electrode on a light leakage distribution in a dark state is simulated. The slit angle a of the slits of the conventional pixel electrode is 45 degrees. When the slit angle a of the slit of the pixel electrode is 45 degrees, the corresponding light leakage distribution in the dark state is shown in FIG. 5. It can be seen from FIG. 5 showing a schematic diagram of the light leakage distribution in the dark state that when a slit angle of slits of the pixel electrode is 45 degrees, the area LG with serious light leakage in the dark state is distributed between the horizontal viewing angle (0 degree or 180 degrees) and the vertical viewing angle (90 degrees or 270 degrees).

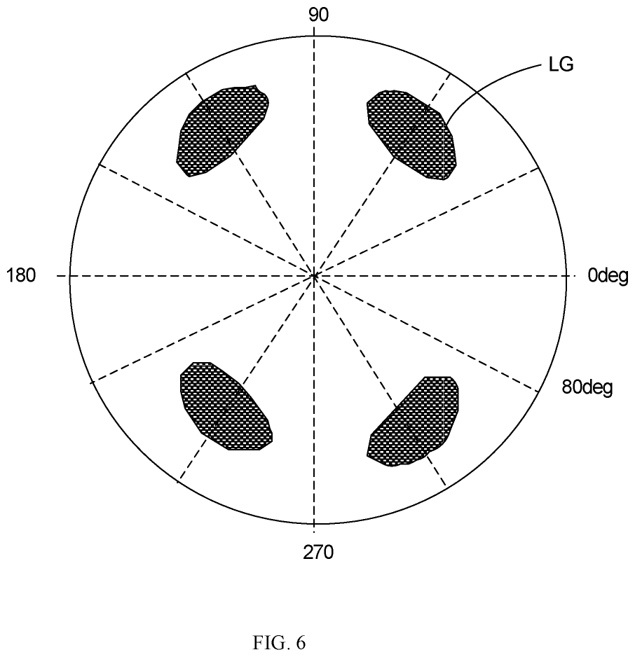

Further, compared to a side viewing angle of 60 degrees relative to a normal direction of the liquid crystal display, in different pixel electrodes, when the slit angle a of the slit of the pixel electrode is 35 degrees, the corresponding light leakage distribution in the dark state is shown in FIG. 6. It can be seen from FIG. 6 showing a schematic diagram of the light leakage distribution in the dark state that when the slit angle a of the slit of the pixel electrode is 35 degrees, an area LG with serious light leakage in the dark state is close to the vertical viewing angle (90 degrees or 270 degrees).

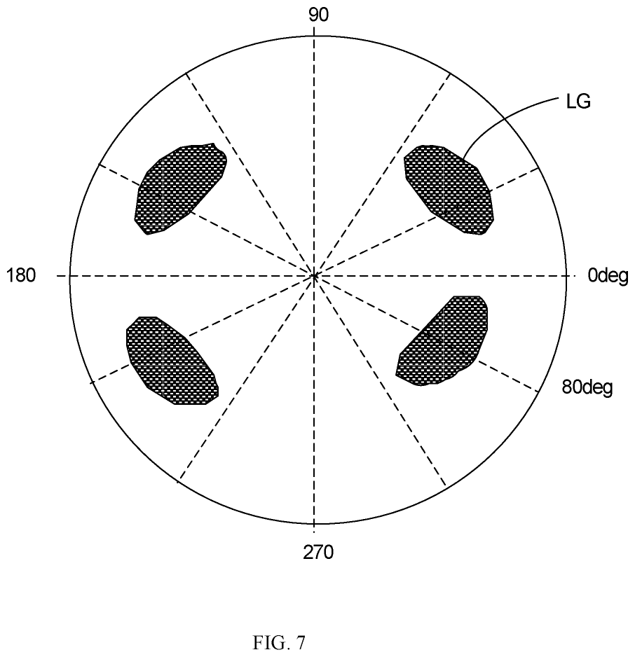

Further, when the slit angle a of the slit of the pixel electrode is 55 degrees, the corresponding light leakage distribution in the dark state is shown in FIG. 7. It can be seen from FIG. 7 showing a schematic diagram of the light leakage distribution in the dark state that when the slit angle a of the slit of the pixel electrode is 55 degrees, the area LG with serious light leakage in the dark state is close to the horizontal viewing angle (0 degrees or 180 degrees).

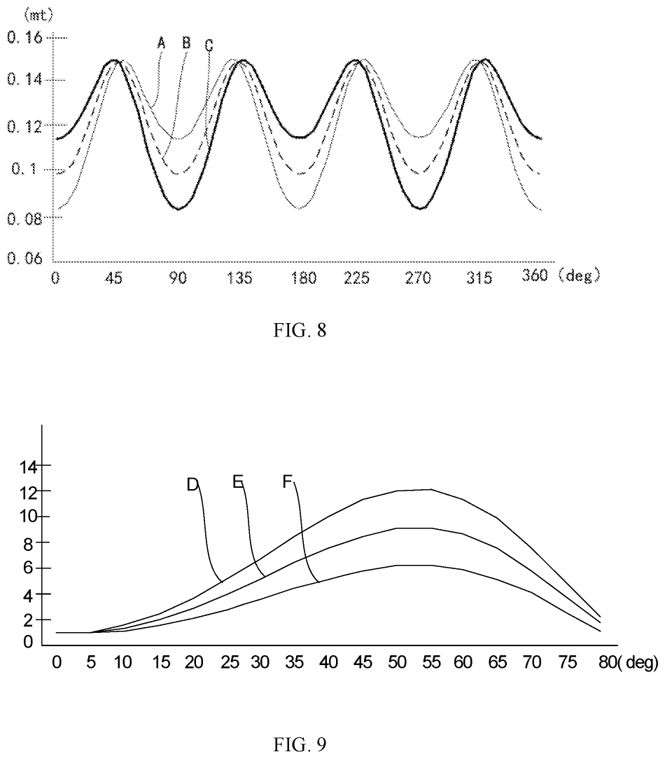

The brightness corresponding to different slit angles of pixel electrodes in a dark state at different viewing angles is shown in FIG. 8. In FIG. 8, the curve A represents the brightness value in the dark state corresponding to each viewing angle when the slit angle a of the pixel electrode is 35 degrees, curve B represents the brightness value in the dark state corresponding to each viewing angle when the slit angle a of the pixel electrode is 45 degrees, and the curve C represents the brightness value in the dark state corresponding to each viewing angle when the slit angle a of the pixel electrode is 55 degrees. It can be seen from the brightness distribution diagram shown in FIG. 8 that when the slit angle a of the slit of the pixel electrode is 35 degrees, the brightness in the dark state at the horizontal viewing angle (0 degrees or 180 degrees) can be effectively reduced. When the slit angle a of the slit of the pixel electrode is 55 degrees, the brightness in the dark state at the vertical viewing angle (90 over 270 degrees) can be effectively reduced. It should be noted that the vertical axis in FIG. 8 represents the brightness value in the dark state corresponding to each viewing angle, and the horizontal axis represents the angle of the viewing angle in the dark state. The dark state of the LCD screen should be as dark as possible. The larger the brightness value, the more serious the light leakage and the lower the contrast in the dark state.

Further, according to the above simulation data, it can be seen that the slit angle of the slit of the pixel electrode becomes smaller, and the area with serious light leakage in the dark state viewing angle is close to the vertical viewing angle (90 degrees or 270 degrees), so the light leakage in the dark state at the horizontal viewing angle can be improved. The slit angle of the slit of the pixel electrode becomes larger, and the area with serious light leakage in the dark state is close to the horizontal viewing angle (0 degrees or 180 degrees), so the light leakage in the dark state at the vertical viewing angle can be improved.

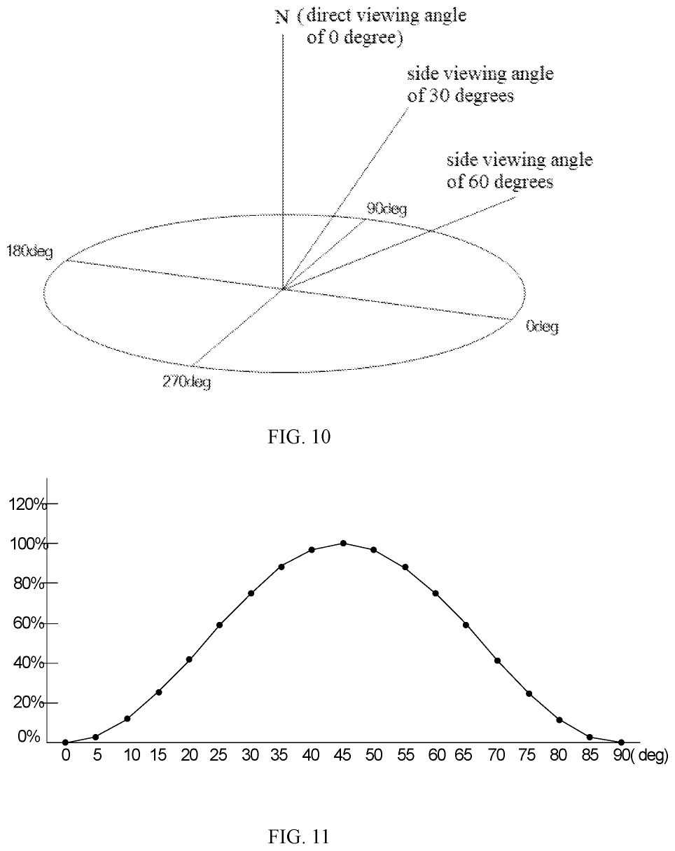

Further, when the slit angles of the pixel electrodes are set to have different angles, the effect in the dark state at the horizontal viewing angle is simulated, and the result is shown in FIG. 9. In FIG. 9, the horizontal axis represents different viewing angles, and the vertical axis represents the light leakage value in the dark state at the horizontal viewing angle. The light leakage value here is a ratio, whose details are as follows: The light leakage value in the dark state at the horizontal viewing angle usually refers to a ratio at the horizontal viewing angle (0 deg or 180 deg) between the brightness value at a side viewing angle of 30 degrees or 60 degrees relative to a normal direction of the LCD screen and the brightness value at the front viewing angle (0 degrees). It should be noted that, referring to FIG. 10, the horizontal viewing angle (0 deg or 180 deg) and vertical viewing angle (90 deg or 180 deg) are perpendicular to a normal line N of the LCD screen, and the front viewing angle is also defined as 0 degrees along the direction of the normal line of the LCD screen. The side viewing angle of 30 degrees referred to an angle of 30 degrees with respect to the normal line N. Of course, the side viewing angle of 60 degrees referred to an angle of 60 degrees with respect to the normal line N. The curve D represents the light leakage value in the dark state at the horizontal viewing angle corresponding to different viewing angles when the slit angle a of the pixel electrode is 55 degrees. The curve E represents the light leakage value in the dark state at the horizontal viewing angle corresponding to different viewing angles when the slit angle a of the pixel electrode is 45 degrees. The curve E represents the light leakage value in the dark state at the horizontal viewing angle corresponding to different viewing angles when the slit angle a of the pixel electrode is 35 degrees. It can be seen from FIG. 9 showing distribution diagram of the influence in a dark state at a horizontal viewing angle corresponding to different slit angles that when the slit angle is 35 degrees (curve F), the light leakage value in the dark state at the horizontal viewing angle corresponding to different viewing angles is lower than the light leakage value in the dark state at the horizontal viewing angle corresponding to different viewing angles when the slit angle is 55 degrees (curve D). That is, as the slit angle decreases, the light leakage value in the dark state at the horizontal viewing angle decreases, thereby alleviating the light leakage in the dark state at the horizontal viewing angle. The smaller the light leakage value in the dark state at the horizontal viewing angle, the lighter the light leakage in the dark state at the horizontal viewing angle, and the better the display effect of the LCD screen. This further illustrates that when the slit angle a is less than 45 degrees, the brightness in the dark state at the horizontal viewing angle can be effectively reduced, and the light leakage in the dark state at the horizontal viewing angle can be improved.

Therefore, in this embodiment, the slit angle a of the slit of the pixel electrode is set in the range of 0° to 39.99°, which effectively reduces the brightness in the dark state at the horizontal viewing angle and improves the light leakage in the dark state horizontal viewing angle.

It should be noted that the pixel electrode of this embodiment takes the two domains shown in FIG. 4 as an example to illustrate the setting of the slit angles of the slits of the pixel electrode, but it does not mean that the pixel electrode structure of the present application is limited to a two domain. The pixel electrode structure of the present application may also include a four-domain structure or an eight-domain structure composed of a main pixel electrode and a sub-pixel electrode, or pixel electrodes of other structures.

In an embodiment, the difference from the foregoing embodiments is that the slit angle a of the slit of the pixel electrode ranges from 34.99 degrees to 39.99 degrees. Specifically, while setting the slit angle a of the slit of the pixel electrode to alleviate the light leakage in the dark state at the horizontal viewing angle, the influence of the slit angle a of the slit of the pixel electrode on the transmittance of the liquid crystal display is also necessary to be considered. Specifically, as shown in FIG. 11, which shows the transmittances corresponding to the different slit angles a of the slits of the pixel electrode, wherein the horizontal axis represents the different slit angle a, and the vertical axis represents the transmittance of the liquid crystal display screen, it can be seen from FIG. 11 that when the slit angle a is near 45 degrees, the transmittance of the liquid crystal display is the largest. As the degree of the slit angle a decreases or increases from 45 degrees, the corresponding transmittance is decreasing.

In summary, on the premise of alleviating the light leakage of the liquid crystal display in the dark state at the horizontal viewing angle, and reducing the influence on the transmittance of the liquid crystal display, the range of the slit angle a of the slit of the pixel electrode is preferably between 34.99 degrees and 39.99 degrees.

In an embodiment, the difference from the foregoing embodiments is that the slit angle a of the slit of the pixel electrode is set in the range of 50.01 degrees to 90 degrees, to alleviate the light leakage of the liquid crystal display in the dark state at the vertical viewing angle. According to the simulation results of alleviating the light leakage of the liquid crystal display in the dark state at the horizontal viewing angle in the above embodiment, it can be seen that when the slit angle a of the slit of the pixel electrode is greater than 45 degrees, the area with serious light leakage in the dark state is close to the horizontal viewing angle, which can effectively reduce the brightness in the dark state at the vertical viewing angle, thereby alleviating the light leakage in the dark state at the vertical viewing angle. Therefore, setting the slit angle a of the slit of the pixel electrode in the range of 50.01 degrees to 90 degrees can alleviate the light leakage of the liquid crystal display in the dark state at the vertical viewing angle. Other details can be referred to the above-mentioned embodiment, which will not be repeated herein for brevity.

In an embodiment, the difference from the foregoing embodiments is that the slit angle a of the slit of the pixel electrode is set in the range of 50.01 degrees to 55.01 degrees. Specifically, while setting the slit angle a of the slit of the pixel electrode to alleviate the light leakage in the dark state at the vertical viewing angle, the influence of the slit angle a of the pixel electrode on the transmittance of the liquid crystal display is also necessary to be considered. According to the transmittance corresponding to different slit angles a of the slits of the pixel electrode shown in FIG. 11, when the slit angle is around 45 degrees, the transmittance of the liquid crystal display is the largest. As the slit angle a decrease or increase from 45, the corresponding transmittance is decreasing. Therefore, under the premise of alleviating the light leakage of the liquid crystal display in the dark state at the vertical viewing angle, and reducing the influence on the transmittance of the liquid crystal display, the range of the slit angle a of the slit of the pixel electrode is preferably set between 50.01 degrees and 55.01 degrees. Other details can be referred to the above-mentioned embodiment, which will not be repeated herein for brevity.

In an embodiment, the difference from the foregoing embodiments is that the slit angle a of the slit of the pixel electrode of the green sub-pixel of the liquid crystal display screen is set to be in the slit angle range in the foregoing embodiments. Specifically, the liquid crystal display screen includes red sub-pixels, green sub-pixels, and blue sub-pixels, wherein sub-pixels of different colors contribute differently to the brightness of the liquid crystal display screen, and the green sub-pixels mainly affect the brightness of the liquid crystal display screen. Therefore, the slit angle a of the slit of the pixel electrode of the green sub-pixel is set to be in the slit angle range in the above embodiment, and the slit angle ranges of the pixel electrodes of the red sub-pixel and the blue sub-pixel can be appropriately widened.

In another embodiment, a display device is provided, which includes the liquid crystal display screen of one of the above embodiments.

According to the above embodiments, it can be known that:

The present application provides a liquid crystal display and a liquid crystal display device. The liquid crystal display includes a first substrate and a second substrate arranged oppositely, a liquid crystal layer disposed between the first substrate and the second substrate, an upper polarizer, and a lower polarizer. The slit angles of the slits of at least part of the pixel electrodes on the first substrate are set to a specific angle. The slit angles ranging from 0 degrees to 39.99 degrees can alleviate light leakage of the liquid crystal display in the dark state at a horizontal viewing angle. The slit angles ranging from 50.01 degrees to 90 degrees can alleviate light leakage of the liquid crystal display in the dark state at the vertical viewing angle. The slit angles ranging from 34.99 degrees to 39.99 degrees can alleviate light leakage of the liquid crystal display in the dark state at the horizontal viewing angle without impacting the transmittance of the liquid crystal display. The slit angle s ranging from 50.01 degrees to 55.01 degrees can alleviate light leakage of the liquid crystal display in the dark at the vertical viewing angle without impacting the transmittance of the liquid crystal display.

While the invention has been described by way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. A liquid crystal display screen, comprising:
a first substrate;
a second substrate disposed opposite to the first substrate;
a liquid crystal layer disposed between the first substrate and the second substrate; and
a plurality of pixel electrodes arranged on a surface of the first substrate facing the liquid crystal layer,
wherein each of the pixel electrodes has a plurality of slits, and slit angles of the slits of at least part of the pixel electrodes are not equal to 45 degrees.

2. The liquid crystal display according to claim 1, wherein the slit angles range from 0 degrees to 39.99 degrees, and are configured to alleviate light leakage at a horizontal viewing angle of the liquid crystal display in a dark state.

3. The liquid crystal display according to claim 2, wherein the slit angles range from 34.99 degrees to 39.99 degrees.

4. The liquid crystal display according to claim 1, wherein the slit angles range from 50.01 degrees to 90 degrees, and are configured to alleviate light leakage at a vertical viewing angle of the liquid crystal display in a dark state.

5. The liquid crystal display according to claim 4, wherein the slit angle ranges from 50.01 degrees to 55.01 degrees.

6. The liquid crystal display according to claim 1, wherein the liquid crystal display further comprises a lower polarizer and an upper polarizer, the lower polarizer is attached to a surface of the first substrate away from the liquid crystal layer, and the upper polarizer is attached to a surface of the second substrate away from the liquid crystal layer.

7. The liquid crystal display according to claim 6, wherein a transmission axis of the lower polarizer is 0 degrees.

8. The liquid crystal display according to claim 7, wherein a transmission axis of the upper polarizer is 90 degrees.

9. The liquid crystal display according to claim 1, wherein the at least part of the pixel electrodes are pixel electrodes of green sub-pixels.

10. The liquid crystal display according to claim 1, wherein a material of the pixel electrode comprises indium tin oxide.

11. A liquid crystal display device, comprising a liquid crystal display, the liquid crystal display comprising:
a first substrate;
a second substrate disposed opposite to the first substrate;
a liquid crystal layer disposed between the first substrate and the second substrate; and
a plurality of pixel electrodes arranged on a surface of the first substrate facing the liquid crystal layer,
wherein each of the pixel electrodes has a plurality of slits, and slit angles of the slits of at least part of the pixel electrodes are not equal to 45 degrees.

12. The liquid crystal display device according to claim 11, wherein the slit angles range from 0 degrees to 39.99 degrees, and are configured to alleviate light leakage at a horizontal viewing angle of the liquid crystal display in a dark state.

13. The liquid crystal display device according to claim 12, wherein the slit angles range from 34.99 degrees to 39.99 degrees.

14. The liquid crystal display device according to claim 11, wherein the slit angles range from 50.01 degrees to 90 degrees, and are configured to alleviate light leakage at a vertical viewing angle of the liquid crystal display in a dark state.

15. The liquid crystal display device according to claim 14, wherein the slit angles range from 50.01 degrees to 55.01 degrees.

16. The liquid crystal display device according to claim 11, wherein the liquid crystal display further comprises a lower polarizer and an upper polarizer, the lower polarizer is attached to a surface of the first substrate away from the liquid crystal layer, and the upper polarizer is attached to a surface of the second substrate away from the liquid crystal layer.

17. The liquid crystal display device according to claim 16, wherein a transmission axis of the lower polarizer is 0 degrees.

18. The liquid crystal display device according to claim 17, wherein a transmission axis of the upper polarizer is 90 degrees.

19. The liquid crystal display device according to claim 11, wherein the at least part of the pixel electrodes are pixel electrodes of green sub-pixels.

20. The liquid crystal display device according to claim 11, wherein a material of the pixel electrode comprises indium tin oxide.
